(19) United States
(12) Patent Application Publication
(10) Pub. No.: US 2003/0155769 A1
(43) Pub. Date: Aug. 21, 2003

(54) Coupling for rotary drill strings

(76) Inventor: Todd A Haines, Mackay (AU)

Correspondence Address: Hudak Shunk & Farine Co, Suite 307, 2020 Front Street, Cuyahoga Falls, OH, 44221, US

(21) Appl. No.: 10/333,315

(22) PCT Filed: Jul. 23, 2001
(86) PCT No.: PCT/AU01/00895

(30) Foreign Application Priority Data
Jul. 21, 2000 (AU) PQ 8924
Nov. 29, 2000 (AU) PR 1765
May 31, 2001 (AU) PR 5389

(51) Int. Cl. F16L 35/00

(52) U.S. Cl. 285/333; 285/390

(57) ABSTRACT

Male and female coupling members (120, 130) for a drill string (10) have abutment faces (122, 132), fitted with torque reducing rings (124, 135) of low-friction, material, and multi-start threads (140, 150), with higher lead angles ∝ than forconvention coupling threads, to enable uncoupling of the coupling members (120, 130) at reduced torque.

### BACKGROUND OF THE INVENTION

1. Field of the Invention

THIS INVENTION relates to couplings for rotary drill strings.

The invention also relates to couplings for pipes or tubes which may be screw-threadably connected together. Such pipes or tubes shall be included within the term “rotary drill strings”.

The invention further relates to screw-thread profiles suitable for such couplings.

2. Prior Art

Conventionally, rotary drill strings have a series of component, each with a male coupling member (or pin) arranged for coupling with a complementary female member (or box), to couple together the adjacent components of the drill string. The male coupling is member has a divergent, screw-threaded distal portion, terminated by an annular abutment face; while the female coupling member has a convergent, internally screw-threaded bore (or socket), where the distal end of the female coupling member is terminated by an annular abutment face operable to engage the annular abutment face about the male coupling member.

The rotary drill string components may be coupled and uncoupled up to 1000-1500 times during their life.

It has been known to provide a spacer between the respective annular abutment faces on the male and female coupling members to take up any wear in the respective screw-threaded portions.

As the couplings must be able to transmit considerable rotary torque, there is often considerable difficulty in releasing the coupled male and female coupling members; and it was conventional wisdom that this was due to high frictional contact between the respective threads of the screw-threaded portions.

### SUMMARY OF THE PRESENT INVENTION

However, the inventor has discovered that a major factor in the difficulty in uncoupling the coupling members is due to the high frictional engagement between the respective annular abutment faces. As the known spacers are manufactured of the same, or similar, material, to the material from which the rotary drill strings are manufactured, the high frictional contact between the respective annular abutment faces and the adjacent faces of the spacers also results in difficulty in uncoupling the drill string components.

The inventor has also discovered that the high frictional loads are due to the low lead angle of the 6″ (152.4 mm) BECO threads typically used in conventional couplings.

It is an object of the present invention to provide a ring (or annular body) between the adjacent annular abutment faces of the male and female coupling members (of a rotary drill string) where the ring (or annular body) has a lower co-efficient of friction than the material(s) of the coupling member.

It is a preferred object of the present invention to provide an annular recess in at least one of the annular abutment faces to receive, and locate, the ring.

It is a further preferred object of the present invention to provide a coupling for rotary drill strings incorporated the ring hereinbefore described.

It is a still further preferred object to provide a multi-start thread for the couplings to increase the lead angle of the threads, eg., by 100%.

It is a still further preferred object to harden the threads and abutments on the pin and box couplings.

Other preferred objects will become apparent rom the following description.

In one aspect, the present invention resides in a coupling for a male coupling member and a female coupling member of a rotary drill string as hereinbefore described, wherein:

a ring or annular body, having a lower co-efficient of friction, is interposed, or placed between, the annular abutment faces of the male and female coupling members.

Preferably, an annular recess is provided in at least one of the annular abutment faces to receive, and locate, the ring.

In a second aspect, the present invention resides in a coupling for rotary drill strings (as hereinbefore described) incorporating a ring or annular body, with a lower co-efficient of friction, interposed between the annular abutment faces of the male and female coupling members.

Preferably, the ring or annular body is engaged or received in an annular recess in at least one of the annular abutment faces.

Preferably, the box connection face(s) and/or the connection faces of the coupling members are hardened using an induction hardening process. The faces may be hardened to a depth of, eg., 0.3 to 0.5 mm.

In a third aspect, the present invention resides in a coupling for a male coupling member and a female coupling member of a rotary drill string, wherein the respective members have multi-start threads with relatively high lead angles.

Preferably, the threads and abutment faces on the coupling members are hardened, eg., by heat treatment.

In a fourth aspect, the present invention resides in a coupling for a male coupling member and a female coupling member of a rotary drill string, including the ring or annular body of the first aspect and the multi-start thread of the third aspect.

### BRIEF DESCRIPTION OF THE DRAWINGS

To enable the invention to be fully understood, preferred embodiments will now be described with reference to the accompanying drawings, in which:

FIG. 1 is a side view of typical components in a rotary drill string;

FIG. 2 is a sectional side view of a female coupling member in accordance with the present invention using a standard BECO thread;

FIG. 3 is a similar view of a coupling assembly with a male coupling member in accordance with the present invention, the coupling members having the thread of the present invention;

FIG. 4 is a sectional side view of the ring;

FIG. 5 is an enlarged view of the detail 5 on FIG. 4;

FIG. 6 is a schematic view showing how the lead angle of a thread is measured;

FIGS. 7 to 9 are respective perspective, end and side views of the male coupling (or pin);

FIGS. 10 to 12 are respective perspective end and sectional side views of the female coupling (or box);

FIG. 13 is a sectional side view of the thread profiles of the pin and box on an enlarged scale;

FIGS. 14 to 17 are sectional side views of four alternative multi-start threads for the pin and box; and

FIG. 18 is a sectional side view of a female box connection having an induction hardened face.

(NB: The dimensions and angles indicated on the drawings are illustrative only and are not limiting to the scope of the invention.)

### DETAILED DESCRIPTION OF THE PREFERRED EMBODIMENTS

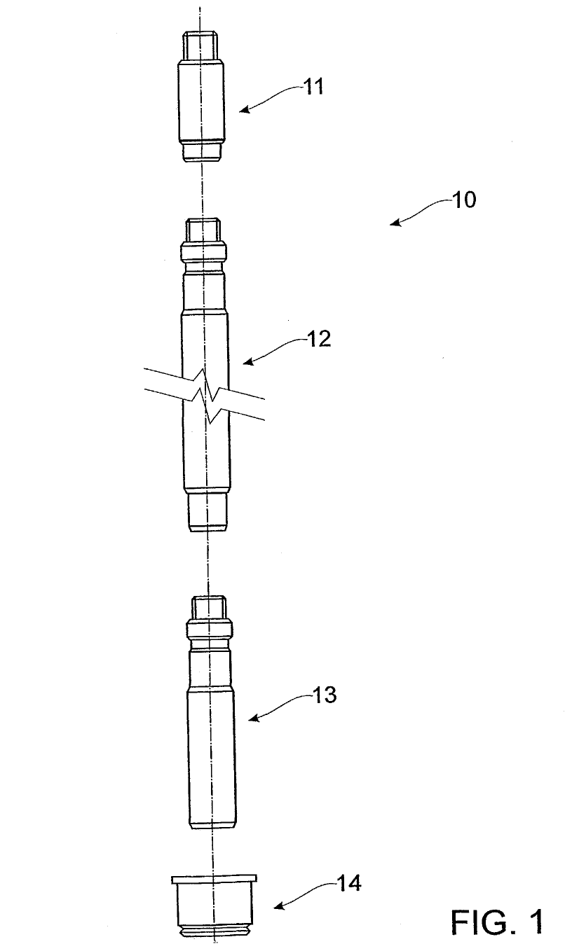

Referring to FIG. 1, a drill string 10 incorporates a top sub 11, a drill steel 12 and a bit sub (or stabiliser) 13 adapted to be connected together and passed through a rotating deck bush 14.

The top sub 11 is connected to a suitable rotary drive (not shown) and a drilling bit (not shown) may be connected to the bit sub (or stabiliser) 13.

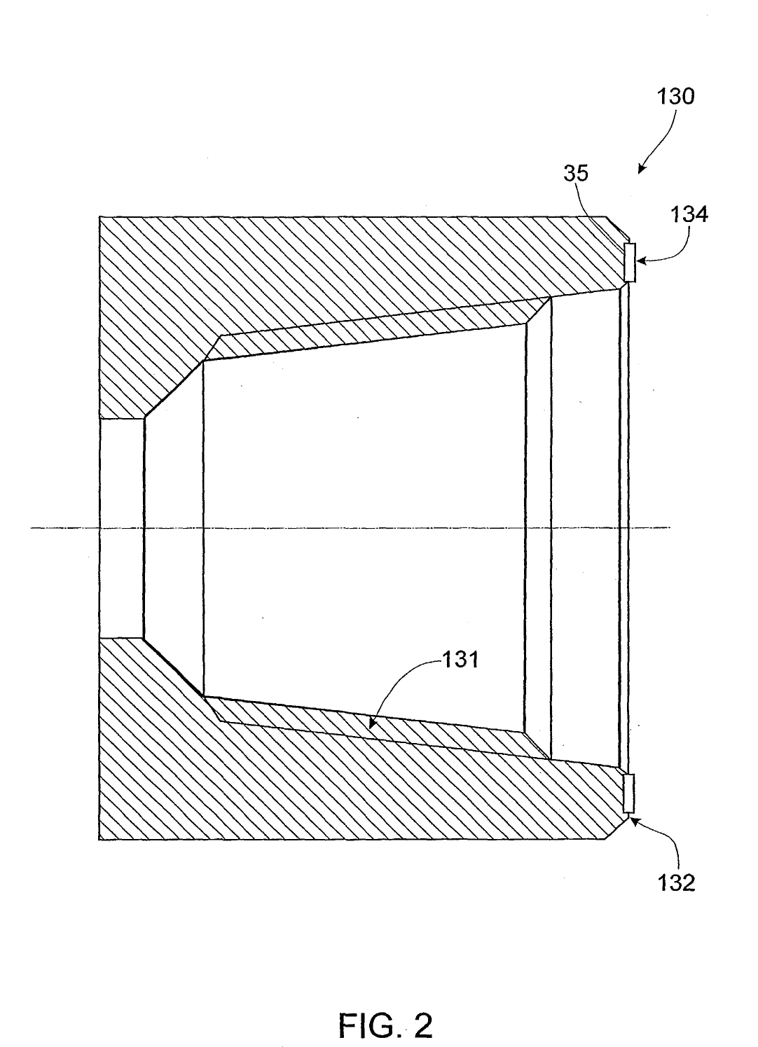

A female coupling member 130 (see FIG. 2) has a convergent internally screw-threaded bore 131 (forming a socket to receive a complementary male coupling member 120), the distal end of the screw-threaded bore 131 being terminated by an annular abutment face 132 at the distal end of the female coupling member.

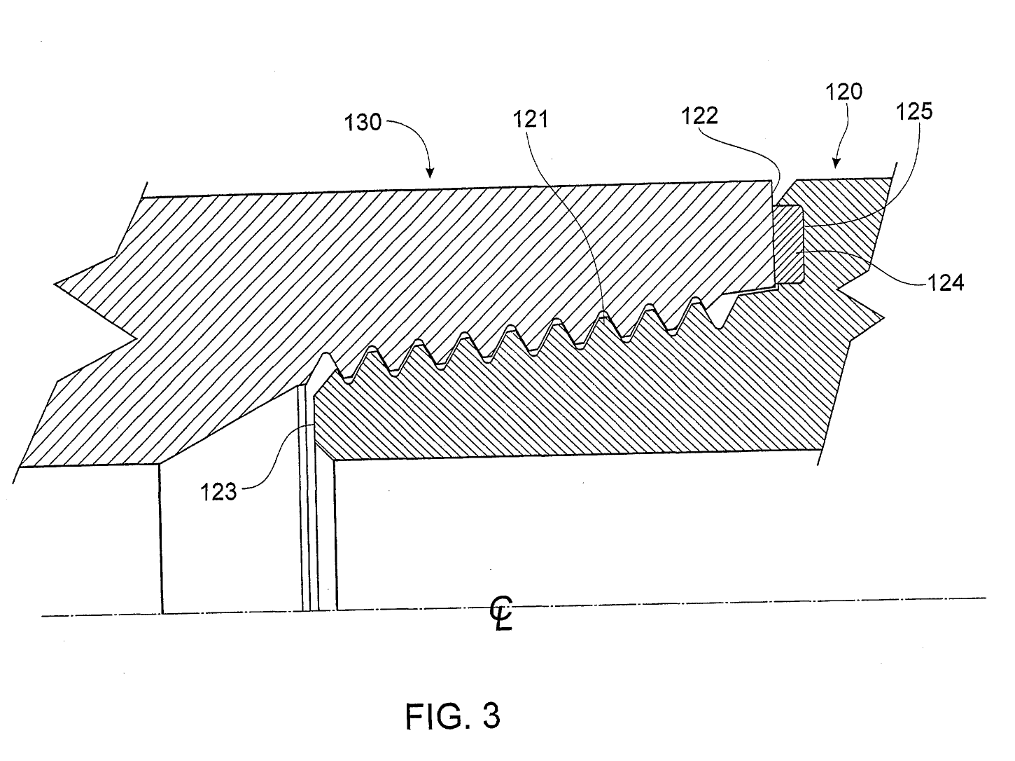

Referring to FIG. 3, a male coupling member 120 has a divergent screw-threaded portion 121 at the end of the drill string component, where an annular abutment face 122 is provided at the end of the screw-threaded portion 121 spaced from the distal end or nose 123.

When the conventional male and female coupling members are screw-threadably engaged, the respective annular abutment faces (equivalent to abutment faces 122, 132) are engaged (or are separated by a steel spacer, not shown) to enable rotary torque to be transferred from one drill string component to the other. As hereinbefore described, an extremely high frictional load is generated between the abutment faces which can make uncoupling of the conventional male and female coupling members extremely difficult (if not impossible).

As shown in FIG. 3, the male coupling member 120 in accordance with the present invention is provided with a torque reducing ring 124 received in an annular recess 125 in the annular abutment face 122, the torque reducing ring 124 extending proud of the annular abutment face 122 by, eg., 2 mm (where the torque reducing ring may be of, eg., 4 mm thickness).

Referring to FIG. 2, the female coupling member 130 in accordance with the present invention has a torque reducing ring 134 received in a recess 135 in the annular abutment face 132 and stands proud of the annular abutment face 132.

The male coupling member 120 may be used with a conventional female coupling member or with the modified female coupling member 130; while the female coupling member 130 may be used with a conventional male coupling member or the modified male coupling member 120.

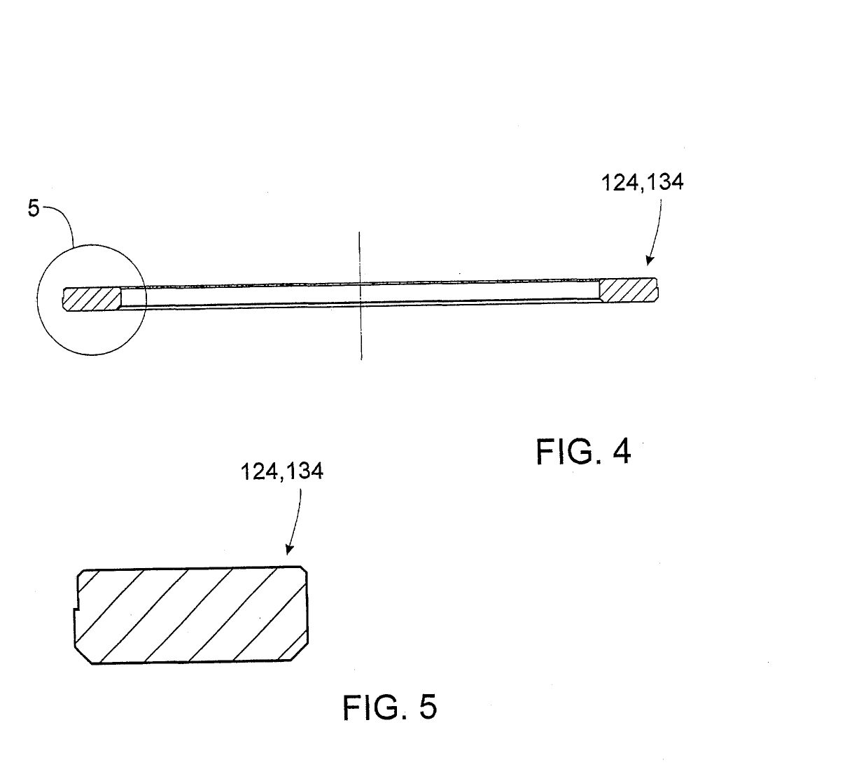

The torque reducing rings 124, 134, shown in more detail in FIGS. 4 and 5, are provided to provide a low-friction surface, to reduce the torque required for uncoupling the members. The rings 123, 134 can be made from many different materials to suit different applications, including ferrous metals or alloys, eg., nitrited AISI 4140, non-ferrous metals or alloys, eg., HTB1 bronze, and/or non-metallic materials such as plastics, elastomers or composites, or a combination of two or more thereof.

The specific purpose of the recesses 125, 135 and the low co-efficient of friction (torque reducing) rings 124, 134 is to enable uncoupling of the coupling members at a lesser torque than is presently being experienced in multi-pass rotary drill strings.

The recesses 125, 135 serve three purposes—firstly, to locate the rings 124, 134 in a radial position when there are forces perpendicular to the axis of the drill string acting on the rings 124, 134 during coupling and uncoupling; secondly, to retain the shape of the rings 124, 134 as they come under load, as a portion of the rings are housed in rigid recesses so that the material of the rings will resist being squashed out of shape (particularly with plastic type rings); and thirdly, to retain the rings on a particular side of the coupling so that they do not slip up or move out of position for the next coupling.

A thin flat washer (particularly of non-metallic material) simply placed between the annular abutment faces cannot be used when couplings are coupled and uncoupled continuously, due to problems with (a) the washer splitting from side loading and (b) sticking to grease on the threads and moving out of position.

The inventor has established that the male and female coupling members 120, 130 (or pins 120 and boxes 130) can be more easily coupled when provided with threads, eg., multi-start threads, which have a higher lead angle than the conventional BECO threads.

The lead angle and the angle formed by a right-angled triangle with one side bearing the pitch diameter of the thread and the other side one half of the thread (or pitch) of the thread. As the threads are tapered, measurement is taken 2.54 m (=1″) from the male thread face.

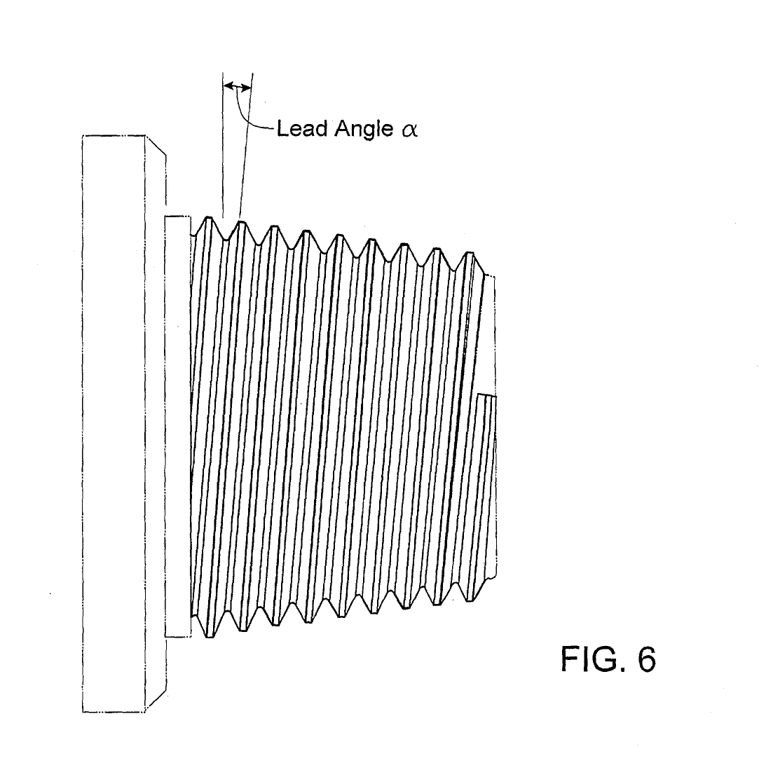

The lead angle a of the threads (see FIG. 6) is defined by the formation:

lead angle α=(½ × lead/pitch diameter) tan⁻¹

For example, a 6″ BECO thread has a pitch diameter 25.4 from the pin face=152.4 mm (=6″) and a lead (or pitch) of 12.7 mm (=0.5″).

$$\begin{matrix}∴ lead angle α = ( 1 / 2 \times 12.7 / 152.4 ) {tan}^{- 1} \\ = {2.39}^{°}\end{matrix}$$

Typical lead angles for conventional BECO threads are as follows:

| | |
|---|---|
| 3″ | 4.75° |
| 3½″ | 4.08° |
| 4″ | 3.58° |
| 4½″ | 3.18° |
| 5¼″ | 3.18° |
| 6″ | 2.39° |
| 8″ | 1.79° |

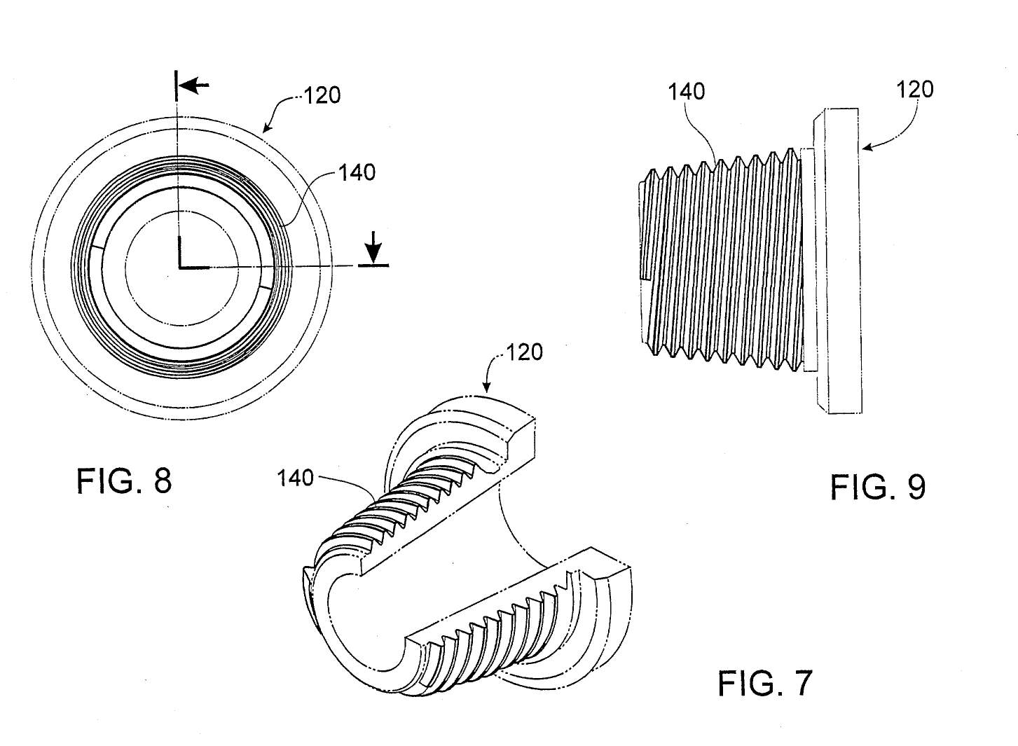

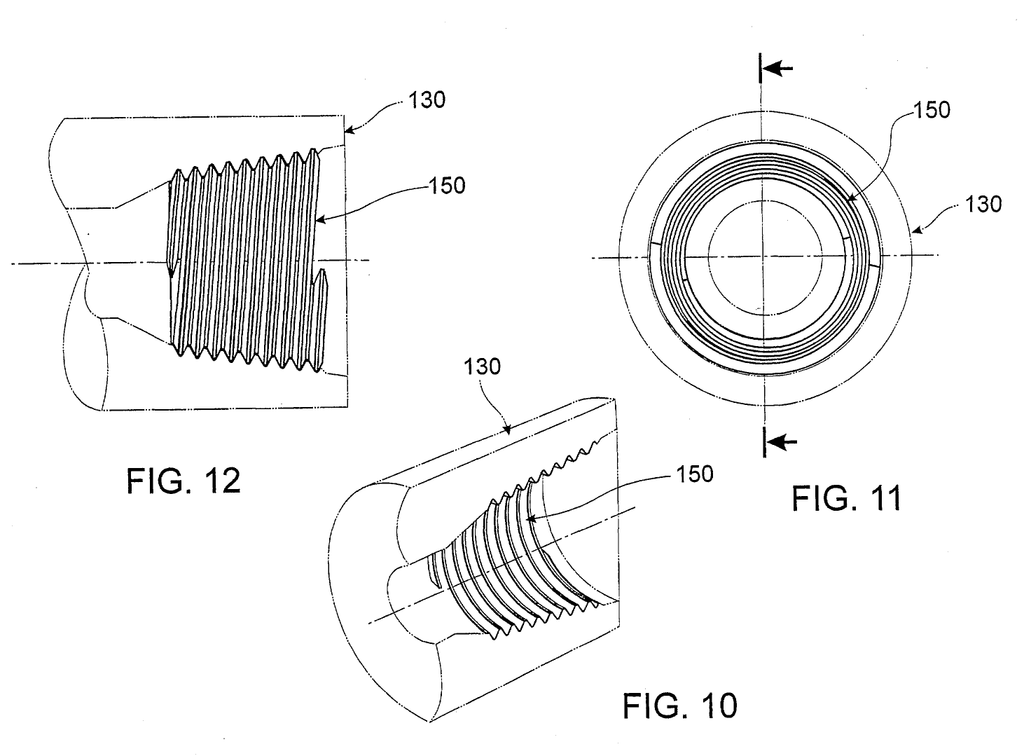

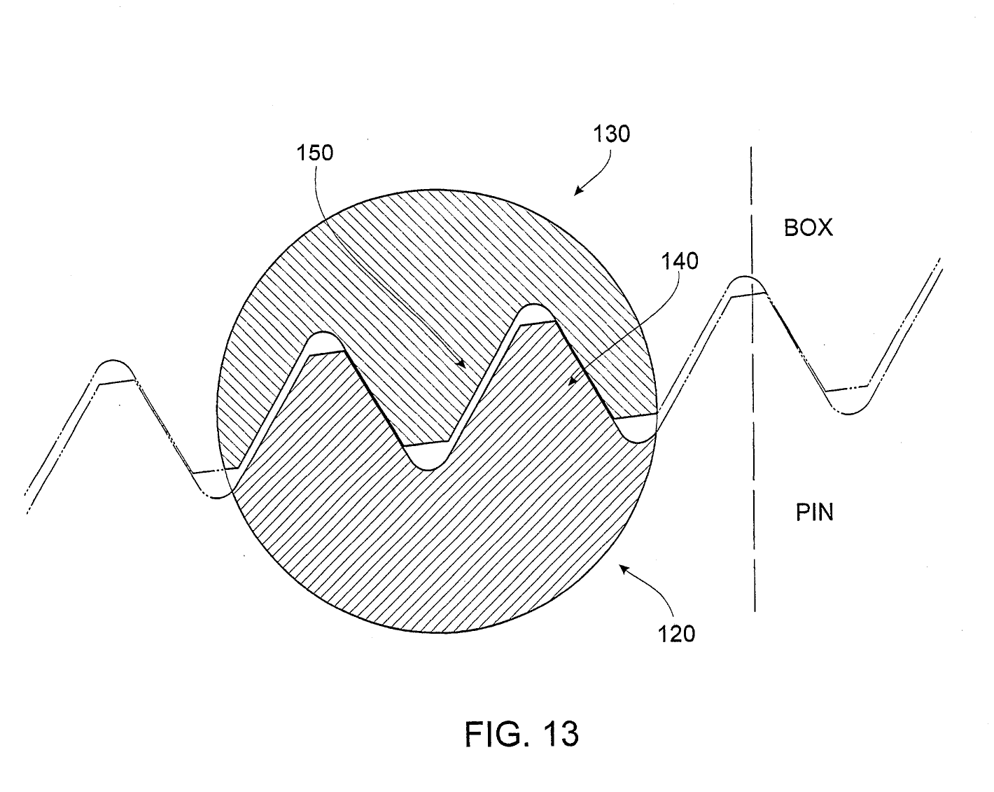

As shown in FIGS. 7 to 13, the male coupling (or pin) 120 and female coupling (or box) 130 are provided with multi-start, in particular 2-start, threads 140, 150, where the respective angles are double the lead angle of the equivalent diameter BECO threads, eg:

| | BECO THREAD | PRESENT INVENTION |
|---|---|---|
| DIAMETER | LEAD ANGLE | LEAD ANGLE |
| 6″ | 2.39° | 4.76° |
| 8″ | 1.79° | 3.58° |

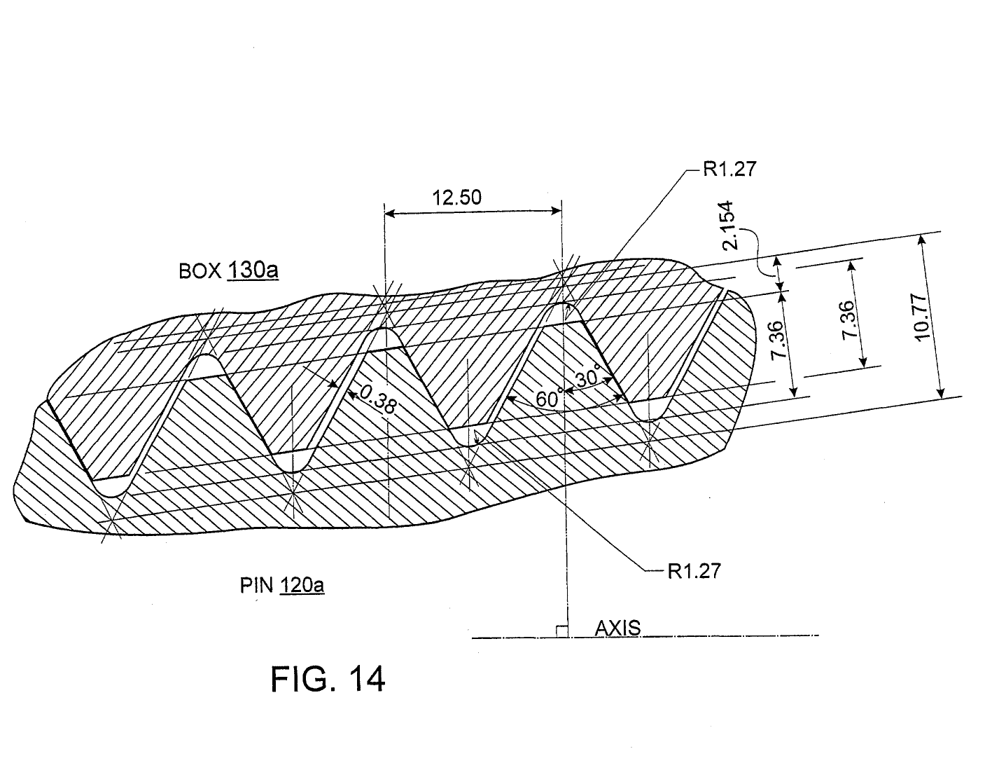

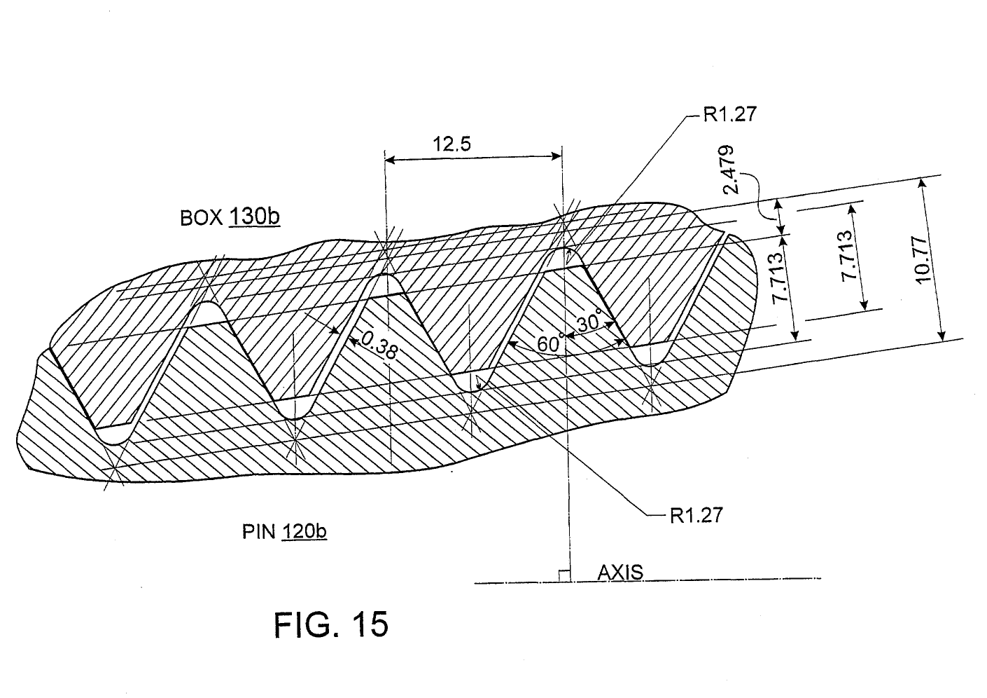

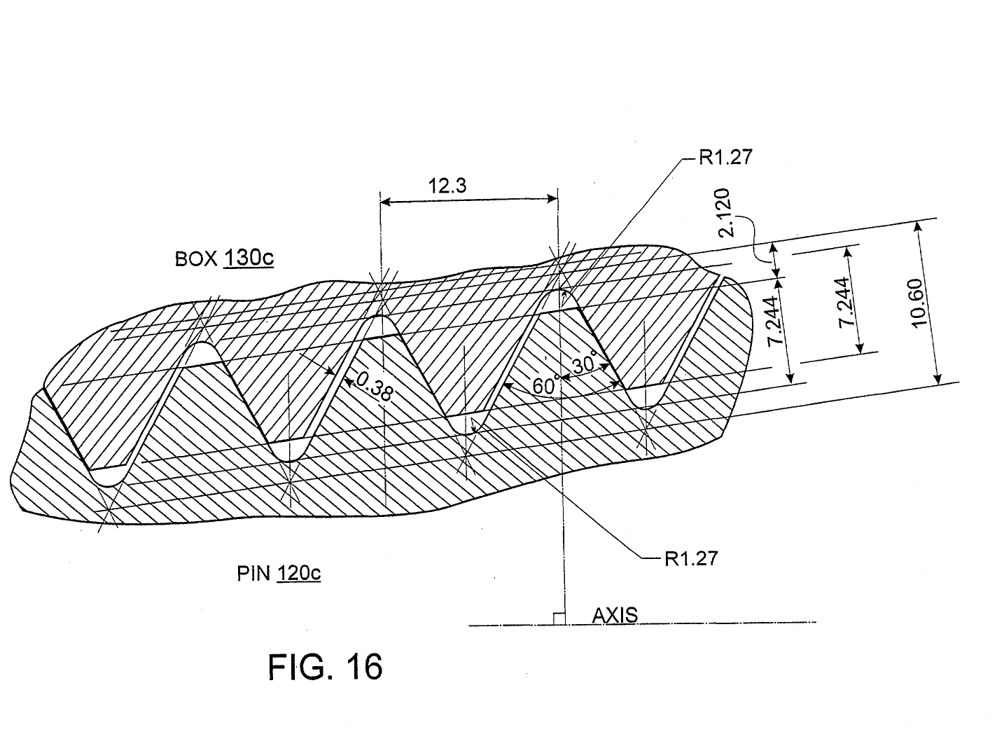

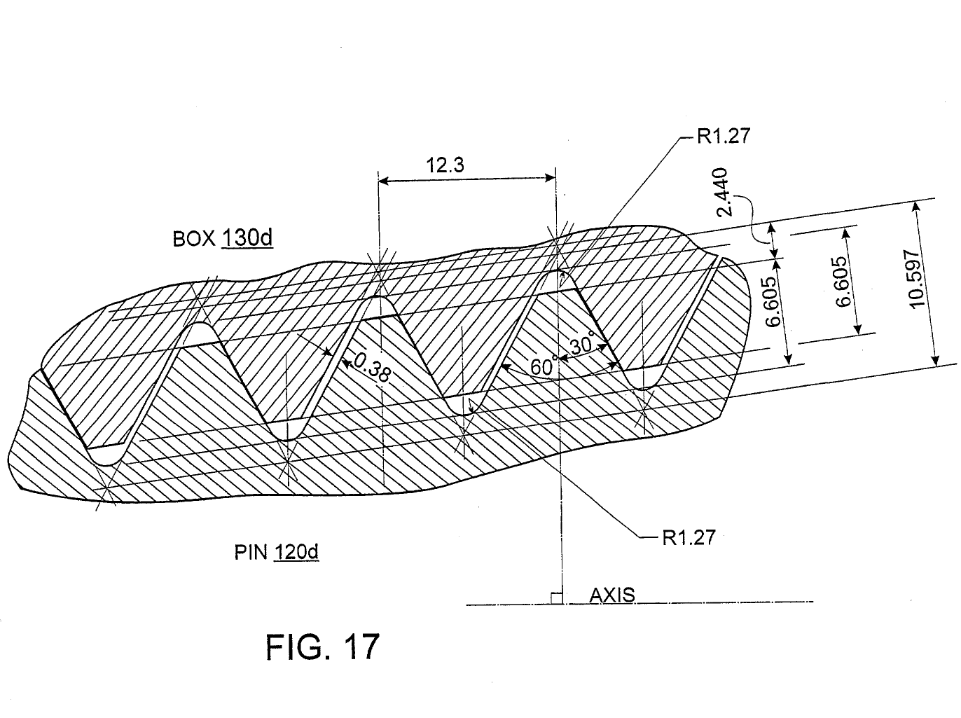

Referring to FIGS. 14 to 17, each discloses an alternative two-start thread (pair) for the pins (or male couplings) 120a-d and the boxes (or female couplings) 130a-d. NB: The invention is not limited to the particular dimensions/angles shown in the drawings. In the embodiments of the screw-threads in FIGS. 14 to 17, respective threads have frusto-conical peaks and substantially semicircular valleys, where the leading and trailing faces of the threads are both inclined at 30° included angles to planes radial to the axis of the threads.

The lead angles α of the threads are larger than the lead angles of the standard 6″ and 8″ BECO threads and indeed, are typically twice as large (eg., 4.76° and 4.58° compared with 2.39° and 1.79° respectively, for the BECO threads). This decreases the pressure on the abutment faces 125, 135 and thereby the loadings ono the torque reducing rings 124, 134. This reduces the wear rates on the rings, increasing their service life and/or allowing “softer” ring to be used (eg., HTB1 bronze instead of nitrited AISI 4140).

The larger lead angles of the multi-start threads also reduces the amount of torque required to couple the couplings.

The performance of the threads can be further improved by hardening, including heat treatments such as nitrating, case hardening and through hardening. The hardening will increase the number of time a coupling can be coupled and uncoupled due to the harder surfaces on the threads.

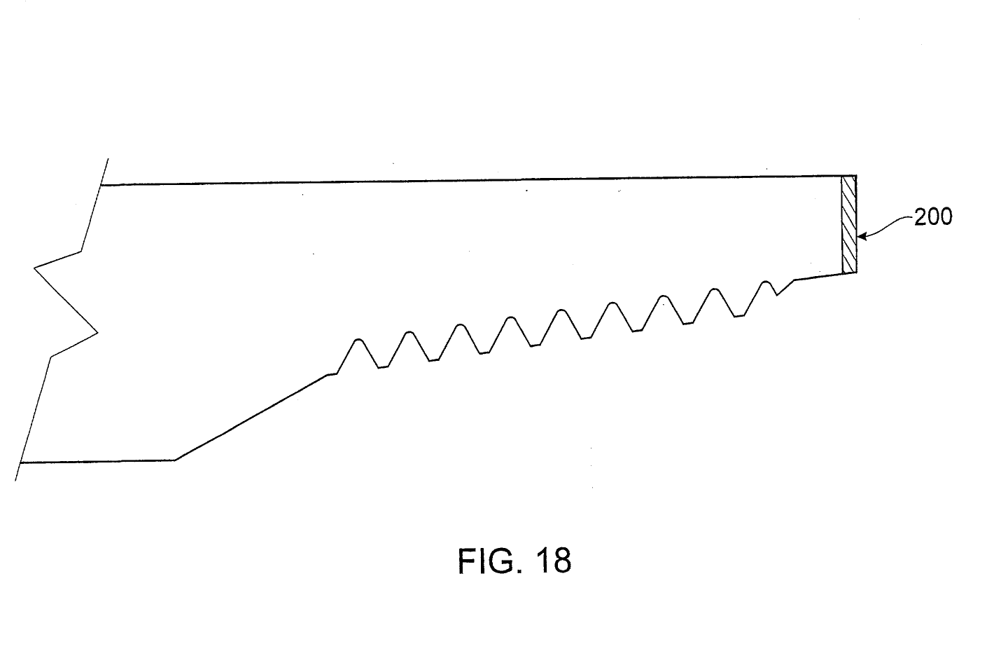

The applicant has trialled the use of the face rings as hereinbefore described, on 6″ and 4½″ BECO pin connections. These face rings were made from a case hardening steel which is machined, case hardened and then surface ground. The incident of thread lock-up ha been dramatically reduced, especially when used with the two-start threads of FIGS. 14 to 17, as hereinbefore described. There is, however, damage still being done to the face ring due to its contacting the softer box connection face with metal particles in the grease. As shown in FIG. 18, the solution of this problem is to harden the box connection face 200 using the process known as induction hardening. This induction hardening process entails passing an extremely hot electrode slowly past the box connection, heating it to such a temperature that when a water jet spray that follows the electrode is applied, the material is hardened. The depth of harder material, eg., 0.3 to 0.5 mm and its hardness is influenced by the temperature, the box face and the severity of the quench. If the box face is hardened to a similar hardness as the face ring, then both faces will remain smoother during operation and therefore lessen the chance of thread lock-up.

By combining the torque reducing rings with the multi-start threads, the torque required to uncouple the couplings is markedly reduced.

The skilled addressee will appreciate that this invention provides a relatively simple, but very efficient, solution to the problem in the rotary drilling industry of drill strings tightening during the drilling process to such an extent that the drill wrench is incapable of undoing the components.

Various changes and modifications may be made to the embodiments described and illustrated without departing from the present invention.

1. A coupling assembly for a rotary drill string including:
a male coupling assembly or pin, and a complementary female coupling member, or box, operable to couple together adjacent components of the rotary drill string;
the male coupling member having a body with a divergent, screw-threaded distal portion, terminated by an annular abutment face;
the female coupling member, or box, having a convergent, internally screw-threaded bore, or socket, where a distal end of the female coupling member is terminated by an annular abutment face operable to engage the annular abutment face about the male coupling member;
wherein:
a ring or annular body, having a lower co-efficient of friction, is interposed, or placed between, the annular abutment faces of the male and female coupling members to reduce the torque required to uncouple the coupling assembly.

2. A coupling assembly as claimed in claim 1, wherein:
the ring or annular body is engaged or received in an annular recess in at least one of the annular abutment faces.

3. A coupling assembly as claimed in claim 1, wherein:
a respective ring or annular body is engaged or received in respective annular recesses in the respective annular abutment faces.

4. A coupling assembly as claimed in claim 2 or claim 3, wherein:
the ring, or rings, have contact face(s) spaced a distance of 1-2 mm above the annular abutment faces.

5. A coupling assembly as claimed in any one of claims 2 to 4 wherein:
the ring(s) are formed of ferrous metals or alloys, non-ferrous metals and/or non-metallic materials.

6. A coupling assembly as claimed in claim 5 wherein:
the ring(s) are formed of nitrited AISI 440, HTBI bronze, plastic(s) or a combination of two or more thereof.

7. A coupling assembly as claimed in any one of claims 1 to 6 wherein:
the annular abutment face of the male coupling member or female coupling member not provided with the ring or annular body is induction hardened to a depth of 0.3 to 0.5 mm.

8. A coupling assembly as claimed in any one of claims 1 to 7 wherein:
the screw-threaded distal portion, the screw-threaded bore and the annular abutment faces of the male and female coupling members are hardened by heat treatment.

9. A coupling assembly as claimed in any one of claims 1 to 8 wherein:
the screw-threaded distal portion and the screw-threaded bore have complementary screw-thread profiles with a lead angle (as hereinbefore defined) greater than the lead angle of corresponding diameter BECO coupling member.

10. A coupling assembly as claimed in claim 9 wherein:
the lead angle is twice the lead angle of the corresponding diameter BECO coupling member.

11. A coupling assembly as claimed in claim 10 wherein:
the lead angle is in the range of 3.58° to 4.76°.

12. A coupling assembly as claimed in any one of claims 9 to 11 wherein:
the screw-thread profiles are two-start thread profiles.

13. A coupling assembly as claimed in claim 12 wherein:
the two-start thread profiles have respective threads with frusto-conical peaks and substantially semicircular valleys, and where leading and trailing faces of the threads are inclined at 30° inclined angles to plane radial to the axis of the threads.

14. A male coupling member and a female coupling member for the coupling assembly as claimed in any one of claims 1 to 13.

15. A coupling assembly for a rotary drill string including:
a male coupling assembly or pin, and a complementary female coupling member, or box, operable to couple together adjacent components of the rotary drill string;
the male coupling member having a body with a divergent, screw-threaded distal portion, terminated by an annular abutment face;
the female coupling member, or box, having a convergent, internally screw-threaded bore, or socket, where a distal end of the female coupling member is terminated by an annular abutment face operable to engage the annular abutment face about the male coupling member;
wherein:
the screw-threaded distal portion and the screw-threaded bore have complementary screw-thread profiles with a lead angle (as hereinbefore defined) greater than the lead angle of corresponding diameter BECO coupling member.

16. A coupling assembly as claimed in claim 15 wherein:
the lead angle is twice the lead angle of the corresponding diameter BECO coupling member.

17. A coupling assembly as claimed in claim 16 wherein:
the lead angle is in the range of 3.58° to 4.76°.

18. A coupling assembly as claimed in any one of claims 15 to 17 wherein:
the screw-thread profiles are two-start thread profiles.

19. A coupling assembly as claimed in claim 18 wherein:
the two-start thread profiles have respective threads with frustoconical peaks and substantially semi-circular valleys, and where leading and trailing faces of the threads are inclined at 30° inclined angles to plane radial to the axis of the threads.

20. A coupling assembly as claimed in any one of claims 15 to 19, wherein:
a ring or annular body, having a lower coefficient of friction, is interposed, or placed between, the annular abutment faces of the male and female coupling members to reduce the torque required to uncouple the coupling assembly.

21. A coupling assembly as claimed in claim 20, wherein:
the ring or annular body is engaged or received in an annular recess in at least one of the annular abutment faces.

22. A coupling assembly as claimed in claim 20, wherein:
a respective ring or annular body is engaged or received in respective annular recesses in the respective annular abutment faces.

23. A coupling assembly as claimed in claim 21 or claim 22, wherein:
the ring, or rings, have contact face(s) spaced a distance of 1-2 mm above the annular abutment faces.

24. A coupling assembly as claimed in any one of claims 20 to 23 wherein:
the ring(s) are formed of ferrous metals or alloys, non-ferrous metals and/or non-metallic materials.

25. A coupling assembly as claimed in claim 24 wherein:
the ring(s) are formed of nitrited AtSI 440, HTBI bronze, plastic(s) or a combination of two or more thereof.

26. A coupling assembly as claimed in any one of claims 20 to 25 wherein:
the annular abutment face of the male coupling member or female coupling member not provided with the ring or annular body is induction hardened to a depth of 0.3 to 0.5 mm.

27. A coupling assembly as claimed in any one of claims 20 to 26 wherein:
the screw-threaded distal portion, the screw-threaded bore and the annular abutment faces of the male and female coupling members are hardened by heat treatment.
